(19) United States
(12) Patent Application Publication
(10) Pub. No.: US 2014/0362287 A1
(43) Pub. Date: Dec. 11, 2014

(54) MULTI-DIRECTIONAL POSITIONING APPARATUS FOR MOBILE-PHONE CAMERA SHOOTING

(71) Applicant: Chien Fu CHUNG, Taipei City (TW)

(72) Inventor: Chien Fu CHUNG, Taipei City (TW)

(21) Appl. No.: 13/913,593

(22) Filed: Jun. 10, 2013

(51) Int. Cl. H04N 5/232; H04N 5/225

(52) U.S. Cl. CPC H04N 5/23238; H04N 5/2251
USPC 348/376

(57) ABSTRACT

The present invention is related to a multi-directional positioning apparatus for mobile-phone camera shooting, in particular, to a multi-directional positioning apparatus capable of clamping and positioning a mobile phone in a reverse orientation and capable of adjusting angles for the camera lens at temporary positions of eye-level angle (0°), low or high angle such that shots at different angles are taken at predefined angles under temporary positioning in 360° rotation. The multi-directional positioning device allows the mobile-phone lens to be temporarily positioned at eye-level (0°) for taking camera shots at predefined angles under temporary positioning in 360° rotation; and allows the mobile-phone lens to be at temporary positions of low or high angle for taking camera shots at predefined angles under temporary positioning in 360° rotation; and accordingly, these camera shots can be further combined by image software to form 360° cylindrical VR or 720° spherical VR panoramic shots.

### BACKGROUND OF THE INVENTION

1. Technical Field

The present invention is related to a multi-directional positioning apparatus for mobile-phone camera shooting, in particular, to a panoramic shot taken by a mobile-phone camera.

2. Description of Related Art

Generally, panoramic shots can be categorized into: 360° cylindrical VR panoramic shots and 720° spherical VR panoramic shots; in which, the 360° cylindrical VR panoramic shot is one commonly known to the public for panoramic shooting. For such type of panoramic shots, a camera is positioned on a camera stand with a positioning point as an axle to allow equiangular positioning of the camera to rotate 360° and to take shots at various angles in sections. The angle of rotation during the shooting and the number of the camera shots taken at different positioning angles would vary depending upon the different focal lengths of the lenses of the camera, which can be calculated by an equation to determine the number of camera shots to be taken within the 360° angles for different focal lengths of lenses. For example, for lens with a focal length of 17 mm, 8 camera shots shall be taken at different positioning angles in sections (360°÷8=45°); in other words, the camera uses a positioning point as an axle and the shooter needs to be pressed once for every 45° turn of the camera such that a total of 8 camera shots are taken for the later image combination by an image software to form a 360° cylindrical VR panoramic shot.

In addition, for 720° spherical VR panoramic shots, a camera is positioned on a camera stand with the lens being positioned at a high angle, a low angle and an eye-level angle (0°) and positioned camera shooting in an equiangular rotation allows different camera shots to be taken as the camera rotates 360° and is positioned at different angles in addition to the camera shots taken at an up-right high angle of −90° and up-right low angle of +90° respectively. The number of camera shots taken in sections at different positioning angles of the high angle, the low angle, the eye-level angle (0°) and the equiangular shots in the 360° rotation would vary depending upon different focal lengths of the lenses of the camera, which can be calculated by an equation to determine the number of camera shots to be taken within the 360° angles for different focal lengths of lenses. For example, for lens with a focal length of 17 mm, 8 camera shots shall be taken respectively for the camera positioned at the low angle of +30° and the high angle of −30° in the 360° rotation in sections (360°÷8=45°); in other words, the camera uses a positioning point as an axle and the shooter needs to be pressed once every 45° turn of the camera in addition to the camera shots taken at the up-right high angle of −90° and the up-right low angle of +90° respectively such that a total of 18 camera shots are taken for the later image combination by an image software to form a 760° spherical VR panoramic shot.

The aforementioned method of camera shooting is a professional level of technique that requires trained professionals to perform such shooting. Furthermore, the equipment necessary to perform such professional level of panoramic shooting includes such as professional cameras, lenses, camera stand and camera angular rotational positioning stand, which can be very costly as tens of thousands to the general public while the skills required for operating such equipment would also be troublesome to the general public.

Currently, a lot of real estate developers, agents and other amateur camera users demand for panoramic shots; however, they are often barred from obtaining such professional panoramic shots due to the highly expensive equipment. As a result, most of such shots are performed by hired professionals. Nevertheless, the schedules for camera shooting by such professionals may not be easily arranged or accessed to the users, causing the working efficiency of the users to be poor and the costs thereof to be high.

Accordingly, there is a need for improvement to overcome the aforementioned drawback. As most mobile phones are equipped with a camera with shooting functions and are often of great shooting performance, the inventor seeks to achieve the aforementioned 360° cylindrical VR panoramic shots and 720° spherical VR panoramic shots by using the shooting functions of smartphone type of mobile-phone cameras. After years of research and development, the inventor provides a multi-directional positioning apparatus that can be easily operated.

### SUMMARY OF THE INVENTION

The present invention is related to a multi-directional positioning apparatus for mobile-phone camera shooting, in particular, to a multi-directional positioning apparatus capable of clamping and positioning a mobile phone placed in a reverse orientation and capable of adjusting angles in discrete thereof in order to allow the lens of the camera to be at temporary positions of an eye-level angle (0°), low angle or high angle such that camera shots at different angles can be taken at predefined angles under temporary positioning in the 360° rotation in sections. The multi-directional positioning device allows the mobile-phone lens to be temporarily positioned at an eye-level (0°) and to take camera shots at predefined angles under temporary positioning in the 360° rotation in sections and also allows the mobile-phone lens to be adjusted for temporary positions at a low angle or a high angle and to take camera shots at predefined angles under temporary positioning in the 360° rotation in sections; and accordingly, these camera shots can then be further combined by an image software to form a 360° cylindrical VR panoramic shot or a 720° spherical VR panoramic shots.

One of the objectives of the present invention is: to allow the mobile-phone camera to be at an eye-level (0°) and to take camera shots at predefined angles under temporary positioning in the 360° rotation in sections such that these camera shots can be further combined with an image software to form a 360° cylindrical VR panoramic shot; alternatively, to allow the mobile-phone camera to be temporarily positioned at an eye-level (0°), a low angle and a high angle to take camera shots at predefined angles under temporary positioning in the 360° rotation in sections such that these camera shots can be further combined by an image software to form a 720° spherical VR panoramic shot, which is able to solve the problem of insufficient rooms for indoor mobile-phone camera shooting caused by insufficient camera angles thereof at the same time.

### BRIEF DESCRIPTION OF THE SEVERAL VIEWS OF THE DRAWINGS

FIG. 1 is an exploded view of a multi-directional positioning apparatus for mobile-phone camera shooting of the present invention;

FIG. 2 is another exploded view of a multi-directional positioning apparatus for mobile-phone camera shooting of the present invention;

FIG. 3 is a perspective view of a multi-directional positioning apparatus for mobile-phone camera shooting of the present invention;

FIG. 4 is a cross sectional perspective view taken along A-A in FIG. 3;

FIG. 5 is a cross sectional view taken along B-B in FIG. 3;

FIG. 6 is an illustration showing a top view of a multi-directional positioning apparatus for mobile-phone camera shooting of the present invention with a mobile phone clamped thereon;

FIG. 7 is an illustration showing a multi-directional positioning apparatus for mobile-phone camera shooting of the present invention with a mobile phone clamped thereon at an eye-level angle;

FIG. 8 is an illustration showing a multi-directional positioning apparatus for mobile-phone camera shooting of the present invention with a mobile phone clamped thereon at a high angle; and

FIG. 9 is an illustration showing a multi-directional positioning apparatus for mobile-phone camera shooting of the present invention with a mobile phone clamped thereon at a low angle.

### DETAILED DESCRIPTION OF THE EMBODIMENTS OF THE INVENTION

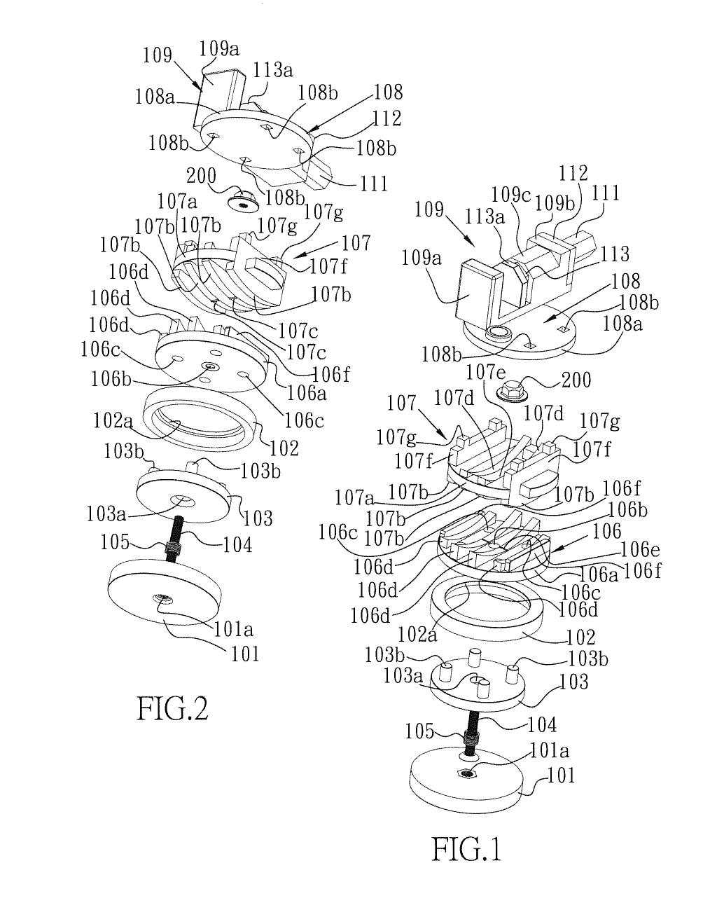

FIG. 1 shows an exploded view of a multi-directional positioning apparatus for mobile-phone camera shooting of the present invention. As shown in the figure, the apparatus comprises:

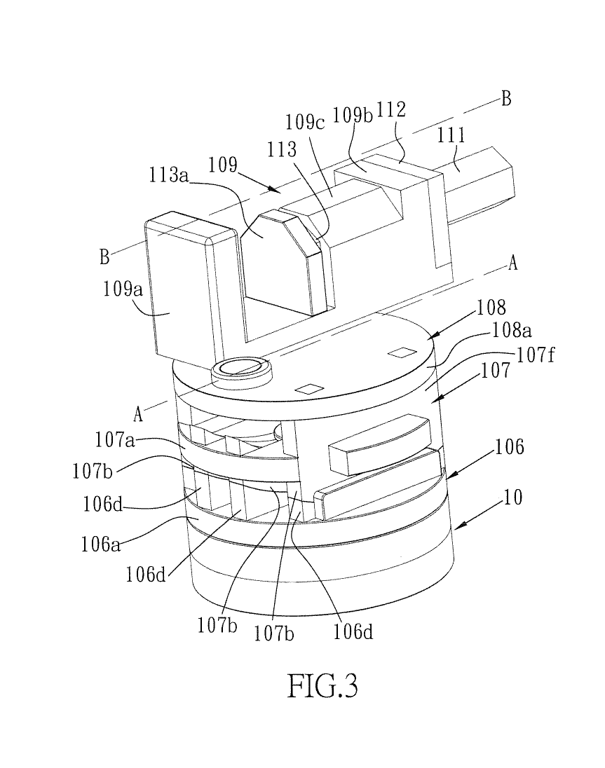

A rotational base 10 (please also refer to FIGS. 2, 3 and 4) comprises an upper ring cap 102 in a form of a ring and includes a protruded ring edge 102a on a top thereof; in which, the upper ring cap 102 comprises a central space provided for receiving a rotational disk 103 therein; a center of the rotational disk 103 comprises an axial hole 103a provided for receiving a screw bolt 104 and a spring 105 inserted therein and a surface thereof comprises a plurality of insertion pins 103b protruded thereon; a bottom seat 101 is further attached to the upper ring cap 102 such that the rotational disk 103 is arranged rotatably between the upper ring cap 102 and the bottom seat 101 without disengagement; and a center of the bottom seat 101 comprises a screw hole 101a provided for a stand to be secured thereon.

A concavely-arched rail unit 106, comprises a bottom plate 106a with a center having an axial hole 106b provided for the screw bolt 104 to be inserted therein, a plurality of insertion holes 106c arranged corresponding to the insertion pins 103b of the rotational disk 103, and a plurality of concavely-arched rail tracks 106d protruded on a surface of the bottom plate 106a and spaced apart from each other; wherein a center of the concavely-arched rail track 106d comprises a positioning groove 106e, and the bottom plate 106a comprises lateral plates 106f on two lateral sides thereof.

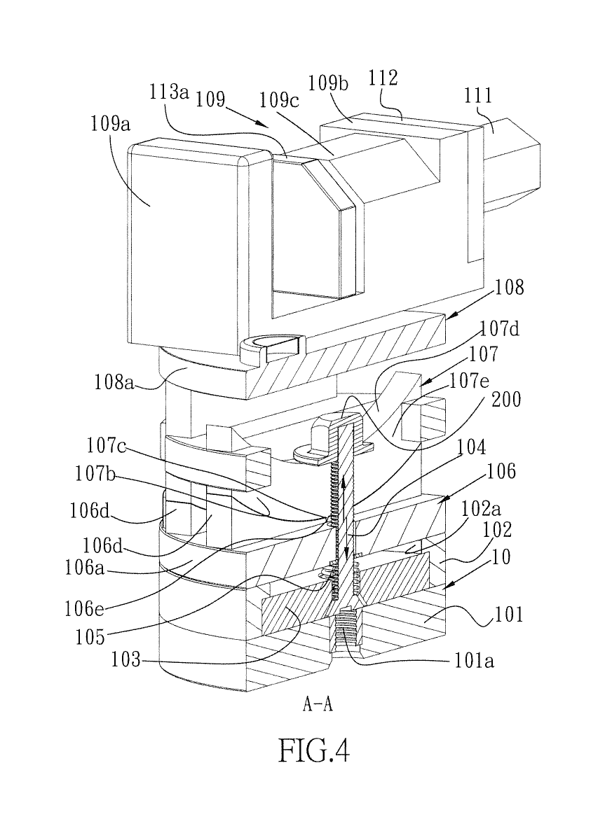

A concavely-arched rail unit 107 comprises a bottom plate 107a with a bottom surface having a plurality of convexly-arched rail tracks 107b engaged correspondingly with each one of the plurality of concavely-arched rail tracks 106d of concavely-arched rail unit 106, and a locking pin 107c (please refer to FIG. 4) protruded at a center of the convexly-arched rail track 107b to engage correspondingly with the positioning groove 106e of the concavely-arched rail track 106d for positioning thereof; and a center of the bottom plate 107a comprises two indented rails 107d spaced apart from each other; and an opening 107e is arranged between the two indented rails 107d and provided to allow the screw bolt 104 to penetrate therethrough and to be fastened with an anti-loose screw nut 200 such that the concavely-arched rail unit 107 and the concavely-arched rail unit 106, are attached with each other to perform a back-and-forth arc movement, and whereby the screw head of screw bolt 104b presses downward against the screw bolt 104 under a tension of the spring 105 in order to utilize the anti-loose screw nut 200 to press downward against the indented rail 107d to form a temporary positioning thereon; and it further comprises two lateral side boards 107f having insertion pins 107g protruded thereon.

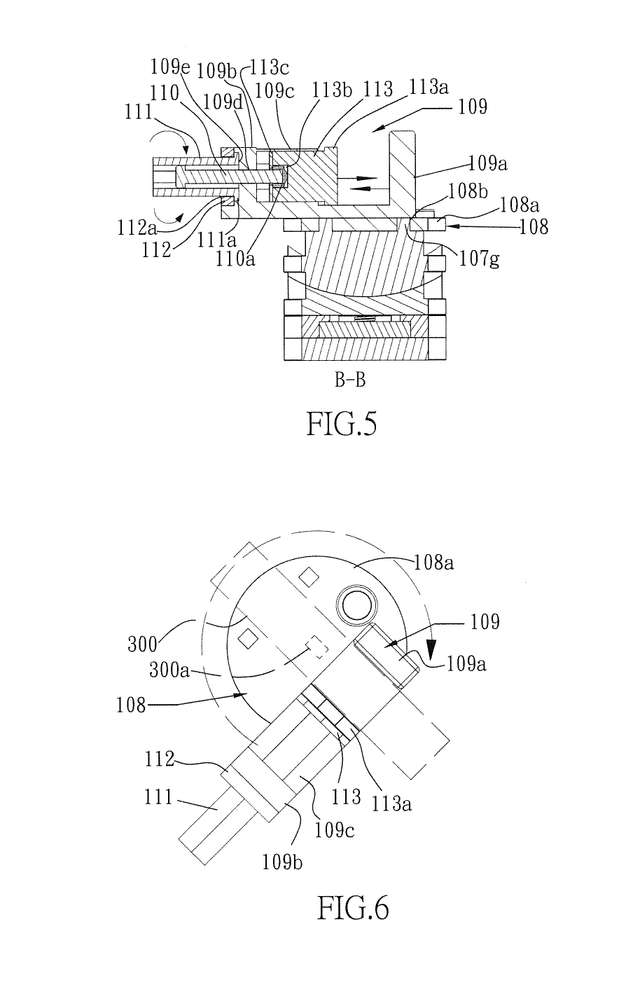

A securement platform 108 (please refer further to FIGS. 5 and 6) comprises a board body 108a having a plurality of insertion holes 108b arranged corresponding to the insertion pins 107g of the two lateral side boards 107f of the concavely-arched rail unit 107 to be inserted thereon; in addition, a securement clamp 109 is provided on the board body 108a and comprises a positioning plate 109a and a tube base 109b having a guidance tube 109c extended thereon; wherein the tube base 109b comprises a screw hole 109d provided for a screw bolt 110 to be fastened thereon and a groove 109e for a rotating handle 111 of a protruding disk 111a to be positioned thereon; and a rear plate 112 with an axial hole 112a is secured onto the tube base 109b such that the rotating handle 111 of the protruding disk 111a is arranged rotatably within the groove 109e without disengagement.

Accordingly to the above, wherein the rotating handle 111 is a multi-angular tube provided between multi-angular screw heads of the screw bolts 110; a push rod 113 is further inserted into the guidance tube 109c, which comprises a top plate 113a on a front end thereof and a moveable axial slot 113b on a rear end thereof and provided to allow the front end of the screw bolt 110 to be fastened between top blocks 110a thereof and to attach the rear plate 113c with the axial hole to the push rod 113 such that the top blocks 110a are arranged rotatably therebetween without disengagement; whereby during the rotation of the rotating handle 111, the screw bolts 110 are rotated together to perform a rotational displacement to drive the push rod 113 to displace and (please refer further to FIGS. 6 to 9) whereby the top plate 113a pushes a mobile phone 300 placed in a reverse orientation toward the positioning plate 109a for clamping thereof; and consequently, when the lens 300a of the mobile phone 300 is at an eye-level angle (0°), a low angle or a high angle, it is always adjacent to the axial center of the rotational base 10 and within the range thereof.

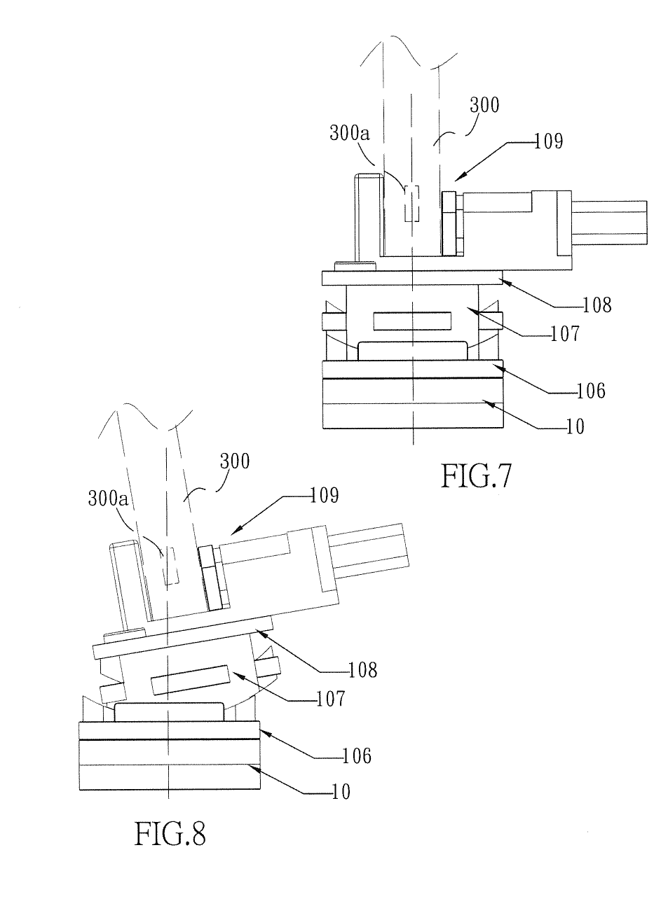

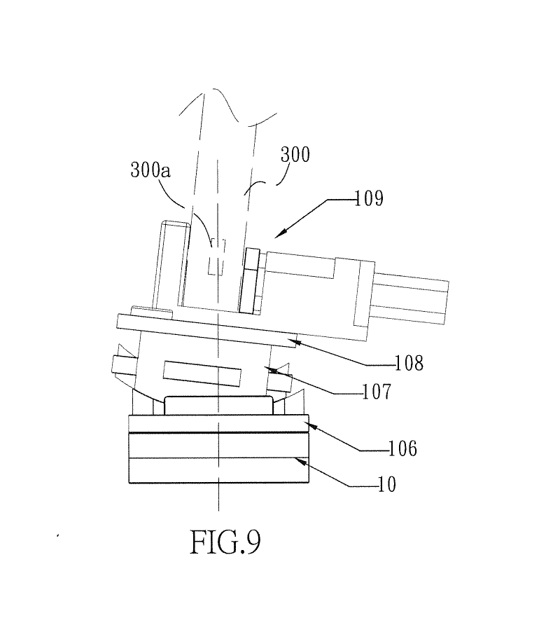

FIG. 6 is an illustration showing a top view of a multi-directional positioning apparatus for mobile-phone camera shooting of the present invention with a mobile phone clamped thereon. As shown in the figure, the mobile phone 300 is clamped by the securement clamp 109 (please also refer to FIG. 7); in which the lens 300a of the mobile phone 300 is at temporarily positioned at the eye-level angle (0°), and the concavely-arched rail unit 107 can be pushed to conjunctionally move the securement platform 108, the securement clamp 109; and the camera 300 (please refer to FIG. 8) is temporarily positioned at the high angle or (please refer to FIG. 8) is temporarily positioned at the low angle, the securement platform 108, the securement clamp 109, the camera 300, the concavely-arched rail unit 107, the concavely-arched rail unit 106, can all be rotated in conjunction simultaneously; and (please refer to FIG. 4) the rotational disk 103 of the rotational base 10 is able to allow the taking of camera shots at predefined angles under temporary positioning in the 360° rotation in sections such that these camera shots can be further combined by an image software to complete a 360° cylindrical VR panoramic shot or a 720° spherical VR panoramic shots.

What is claimed is:

1. A multi-directional positioning apparatus for mobile-phone camera shooting, characterized in that, comprising:
a rotational base, comprising an upper ring cap in a form of a ring and having a protruded ring edge on a top thereof; the upper ring cap comprising a central space provided for receiving a rotational disk therein; a center of the rotational disk comprising an axial hole provided for receiving a screw bolt and a spring inserted therein and a surface of the rotational disk comprising a plurality of insertion pins protruded thereon; a bottom seat further attached to the upper ring cap such that the rotational disk is arranged rotatably between the upper ring cap and the bottom seat without disengagement; and a center of the bottom seat comprising a screw hole provided for a stand to be secured thereon;
a concavely-arched rail unit, comprising a bottom plate with a center having an axial hole provided for the screw bolt to be inserted therein, a plurality of insertion holes arranged corresponding to the insertion pins of the rotational disk, and a plurality of concavely-arched rail tracks protruded on a surface of the bottom plate and spaced apart from each other; wherein a center of the concavely-arched rail track comprises a positioning groove, and the bottom plate comprises lateral plates on two lateral sides thereof;
a convexly-arched rail unit, comprising a bottom plate with a bottom surface having a plurality of convexly-arched rail tracks engaged correspondingly with each one of the plurality of concavely-arched rail tracks of concavely-arched rail unit, and a locking pin protruded at a center of the convexly-arched rail track to engage correspondingly with the positioning groove of the concavely-arched rail track for positioning thereof; and a center of the bottom plate comprising two indented rails spaced apart from each other; and an opening arranged between the two indented rails and provided to allow the screw bolt to penetrate therethrough and to be fastened with an anti-loose screw nut such that the convexly-arched rail unit and the concavely-arched rail unit are attached with each other to perform a back-and-forth arc movement, and whereby the screw head of screw bolt presses downward against the screw bolt under a tension of the spring in order to utilize the anti-loose screw nut to press downward against the indented rail to form a temporary positioning thereon; further comprising two lateral side boards having insertion pins protruded thereon;
a securement platform, comprising a board body having a plurality of insertion holes arranged corresponding to the insertion pins of the two lateral side boards of the convexly-arched rail unit to be inserted thereon; a securement clamp provided on the board body, comprising a positioning plate and a tube base having a guidance tube extended thereon; wherein the tube base comprises a screw hole provided for a screw bolt to be fastened thereon and a groove for a rotating handle of a protruding disk to be positioned thereon; and a rear plate with an axial hole is secured onto the tube base such that the rotating handle of the protruding disk is arranged rotatably within the groove without disengagement;
wherein the rotating handle is a multi-angular tube provided between multi-angular screw heads of the screw bolts; a push rod is further inserted into the guidance tube, comprising a top plate on a front end thereof and a moveable axial slot on a rear end thereof and provided to allow the front end of the screw bolt to be fastened between top blocks thereof and to attach the rear plate with the axial hole to the push rod such that the top blocks are arranged rotatably therebetween without disengagement; whereby during the rotation of the rotating handle, the screw bolts are rotated together to perform a rotational displacement to drive the push rod to displace and whereby the top plate pushes a mobile phone placed in a reverse orientation toward the positioning plate for clamping thereof.
